(19) United States
(12) Patent Application Publication
(10) Pub. No.: US 2004/0172276 A1
(43) Pub. Date: Sep. 2, 2004

(54) POS system

(75) Inventor: Toshihiro Kamo, Kawasaki (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/777,199

(22) Filed: Feb. 13, 2004

(30) Foreign Application Priority Data
Feb. 28, 2003 (JP) 2003-053747

(51) Int. Cl. G06F 17/60

(52) U.S. Cl. 705/1

(57) ABSTRACT

A POS system including a server (30) and a client (40), comprising a first master file (21) formed in a relational data base format and used during an online session between the server and the client, and a second master file (41) having a capacity smaller than the first master file, and used during an offline session between the server and the client, the second master file being downloaded from the server to the client at a time when the client starts service.

### BACKGROUND OF THE INVENTION

1. Field of the Invention

The present invention relates to a POS system and, more particularly, relates to a master file referring system in a POS system.

2. Description of the Related Art

A Point Of Sale (POS) system is known as a computer system for performing inventory/order management, sales statistics, or the like, at a point of sale. The POS system includes a POS terminal (client) used in a convenience store or the like and a center computer (server) connected to the POS terminal, whereby sold items, the number of the sold items, sex and age of the customer, etc. are immediately transmitted to the center.

Even when trouble occurs in the communication between the server and the client, the sales task at the POS terminal cannot be stopped. Therefore, conventionally, a large volume hard disk is provided in the POS terminal, and copies of the master file stored in the server are stored in the hard disk. When trouble occurs between the server and the client, the POS terminal (client) refers to the contents of the hard disk to display pricing or the like.

Related arts are Japanese Unexamined Patent Publication (Kokai) No. 6-309569 and Japanese Unexamined Patent Publication (Kokai) No. 2001-229097

In the above described conventional art, however, there is a problem in that malfunctions easily occur in the hard disk so that the reliability of the POS system is low.

In a Thin-Client Type POS system that does not have a hard disk, the client side does not have a master file having a large capacity. In this case, all of the master files are provided in the server, and by communicating with the server, a price look up (PLU) is carried out to display the price at the POS terminal.

As a result, when the communication with the server is stopped, it becomes impossible to display the price or the like so that the sales task is stopped. To prevent the sales task from being stopped, an operator of the POS terminal must enter the category or the value of the article for sale, which the customer is going to buy. Due to this entering operation, the registering work efficiency becomes lower, and names of articles cannot be printed out on the receipt for the customer.

### SUMMARY OF THE INVENTION

In view of the above problems, an object of the present invention is to provide an offline master file referring system in a POS system in which, during an online session (normal operation period) between the server and the client, the operation is carried out by referring to a file of a relational data base (RDB) type on the server, and during an offline session, a text format file previously down loaded from the server to the client is used. Based on the above concept, the normal PLU can be carried out without stopping the registering operation even during the offline session, and a service similar to the normal service can be provided to customers.

To attain the above object, there is provided, according to a first aspect of the present invention, 1. A POS system, including a server and a client, comprising: a first master file formed in a relational data base format and used during an online session between the server and the client; and a second master file formed in a text format, having a capacity smaller than the first master file, and used during an offline session between the server and the client; the second master file being downloaded from the server to the client at a time when it is necessary for the client: the client comprising: a first referring means for referring to the first master file; and a second referring means for referring to the second master file; the referring means being switched in such a way that, during an online session, the first master file is referred to by the first referring means; and during an offline session, the second master file is referred to by the second referring means.

By the above arrangement, even when the server and the client are in the offline session, the normal PLU can be carried out, without stopping the registering operation, by referring the second master file, whereby the registering operation, by the operator, can be carried out without lowering the efficiency, and a customer can receive a service similar to the normal service.

According to a second aspect of the present invention, the client is a thin client without a hard disk.

According to a third aspect of the present invention, the time when it is necessary for the client is a time at which the client starts service.

According to a fourth aspect of the present invention, the capacity of the second master file is reduced by making a plurality of items in the first master file one item in the second master file.

According to a fifth aspect of the present invention, the capacity of the second master file is reduced by deleting, from the first master file, items which are not used, during the offline session, to form the second master file.

According to a sixth aspect of the present invention, the client comprises a compact flash memory for storing the second master file.

According to a seventh aspect of the present invention, the client comprises a flash disk memory for storing the second master file.

### BRIEF DESCRIPTION OF THE DRAWINGS

The above object and the features of the present invention will be more apparent from the following description of the preferred embodiments of the present invention when read with reference to the accompanying drawings, wherein:

FIG. 1 is a block diagram showing a general construction of a POS system according to an embodiment of the present invention;

FIG. 2 is a block diagram showing a method for preparing a client PLU master file 21 to be stored in the database 20:

FIG. 3 is a diagram showing an example of the construction of the database (DB) server 20 in the POS system shown in FIG. 1;

FIG. 4 is a diagram showing a status of the local master file downloaded to the web server 30 based on the contents of the database server shown in FIG. 3;

FIG. 5 is a diagram showing an example of the construction of the client (POS terminal) 40 including the local master file that is downloaded as the need arises from the web server shown in FIG. 4;

FIG. 6 is a block diagram showing an example of the construction of the storing unit in the client 40;

FIG. 7 is a flowchart for explaining the operation in the client 40 when searching the local master file during an offline session;

FIG. 8 is a diagram showing an example of the contents of the client PLU master file 45 during an offline session;

FIG. 9 is a diagram showing a table of the contents of the client PLU master file 45 shown in FIG. 8;

FIG. 10 is a diagram showing an example of the contents of the category class master file 46 during an offline session;

FIG. 11 is a diagram showing, in a table, the contents of the category class master file 46 as shown in FIG. 10;

FIG. 12 is a diagram showing an example of the contents of the sales person (person in charge) master file 47 during an offline session; and

FIG. 13 is a diagram showing, in a table, the contents of the sales person (person in charge) master file 47 shown in FIG. 12.

### DETAILED DESCRIPTION OF THE PREFERRED EMBODIMENTS

In the following, an embodiment of the present invention will be described with reference to the drawings.

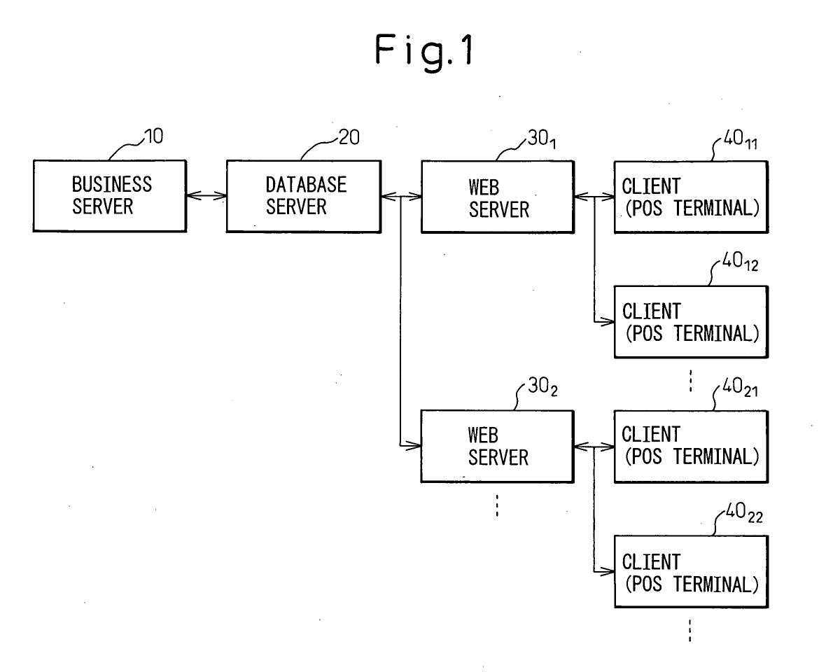

FIG. 1 is a block diagram showing a general construction of a POS system according to an embodiment of the present invention. In the figure, the POS system includes a business server 10 for preparing various master files including a client price look up (PLU) master file, a database 20 for storing the master files prepared by the business server 10, a plurality of web servers 30₁, 30₂, . . . , and a plurality of clients (POS terminals) 40₁₁, 40₁₂, . . . , 40₂₁, 40₂₂, . . . In the following, in order to simplify the explanation, the reference symbol of the web servers is denoted as 30 and the reference symbol of the clients are denoted as 40.

Each client 40, in this embodiment of the present invention, is a thin client that does not have a hard disk. Each client 40 may include a semiconductor memory such as a compact flash memory, flash disk memory or the like, in place of the hard disk. The capacity of the compact flash memory or the like depends on the number of times of the price look up (PLU) operations. If the number of times of operations of the PLU is about 100 thousand, the capacity may be 16 MB. If the number of times of operations of the PLU is about 200 thousand, the capacity may be 32 MB. If the number of times of operations of the PLU is more than 200 thousand, the capacity may be 64 MB.

Each of the web servers 30 carries out communication with a client that is working under the web server. The web server provides data that is required, by the client, during an online session between the web server and the client. According to the embodiment of the present invention, each of the web servers 30 includes a master file to which the client refers during the online session. The capacity of the master file is smaller than the capacity of the database. When trouble occurs in communication between the web server 30 and the client 40, or between the database server 20 and the web server 30, the client 40 switches to an offline state.

The capacity of data to be prepared for providing the data from the web server 30 to the client 40 during an online session is about 3.9 MB when the number of PLU files is ten thousand. In contrast, the capacity of data in the flash memory to which the client refers during an offline session is only about 600 KB which is greatly smaller than 3.9 MB.

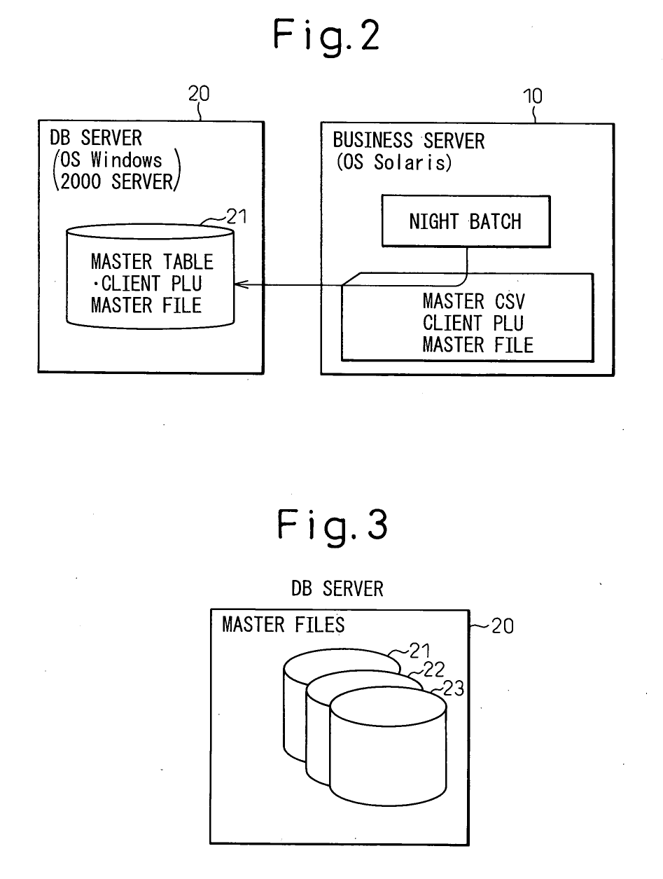

FIG. 2 is a block diagram showing a method for preparing a client PLU master file 21 to be used during an online session and to be stored in the database 20. The client PLU master file 21 is prepared by batch processing during a period when the client (POS terminal) does not work, for example, at night. The operating system (OS) in the business server 10 is “Solaris” in this embodiment. However, it may be another OS. The prepared file is, for example, a CSV file which prepares a client PLU master file based on the upper n items (n: externally set natural number) of the sum of the single goods. The larger the number of the types of the goods or the larger the number of shops, the larger the number of items in the PLU. The client PLU master file 21 prepared in the business server 10 is transferred to the database server 20 by a file transfer affected by a link express alternate function.

FIG. 3 shows an example of the construction of the database (DB) server 20 in the POS system shown in FIG. 1. In the FIG. 21 is a client PLU master file for storing prices of goods corresponding to respective clients, 22 a category master file for storing categories of the goods and a category class master file for storing classes in each category, and 23 a sales person (person in charge) master file for storing codes of sales persons (persons in charge). Regarding the sales persons and the persons in charge, in a department for example, a sales person is usually different from an operator who handles the POS terminal. In such a case, a sales person master file and a person in charge master file may be formed separately according to necessity. In the master files 11-13, all items of respective items are stored. Each master file in the database 20 is a file used online.

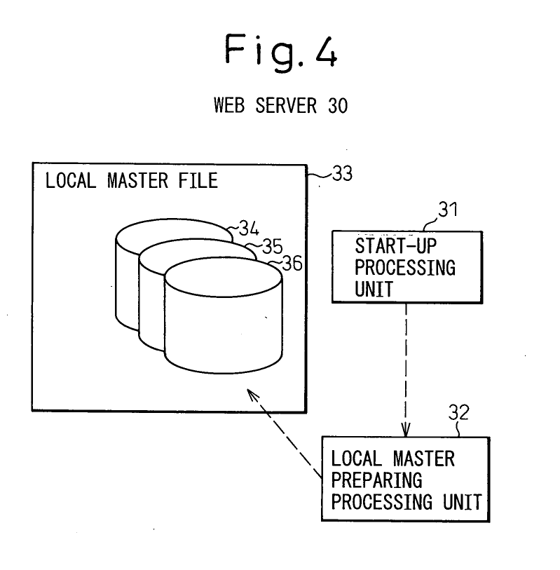

FIG. 4 is a diagram showing a local master file 33 downloaded to the web server 30. In order to perform online communication, the capacity of the local master file 33 is made to be smaller than the capacity of the master file 20. In the FIG. 31 is a web server start-up processing unit, 32 a local master preparing processing unit for preparing the local master based on the master file in the database shown in FIG. 2, and 33 a local master file prepared by the local master preparing processing unit 31.

The local master file 33 includes a client PLU master file 34, a category class master file 35 representing category master files and classes in respective categories, and a sales person (person in charge) master file 36 for storing codes of the sales persons (persons in charge).

The capacity of each of these master files 34-36 is smaller than the data capacity of each of the master files 21-23 so that the capacity of each of the master files 34-36 is the minimum necessary for the client 40 when the client 40 uses the one of the master files 34-36 in an offline session.

Although it is not shown, there is at least one master file that is to be used during an online session. The capacity of the master file to be used during the online session is the same as the capacity of the master file in the database 20.

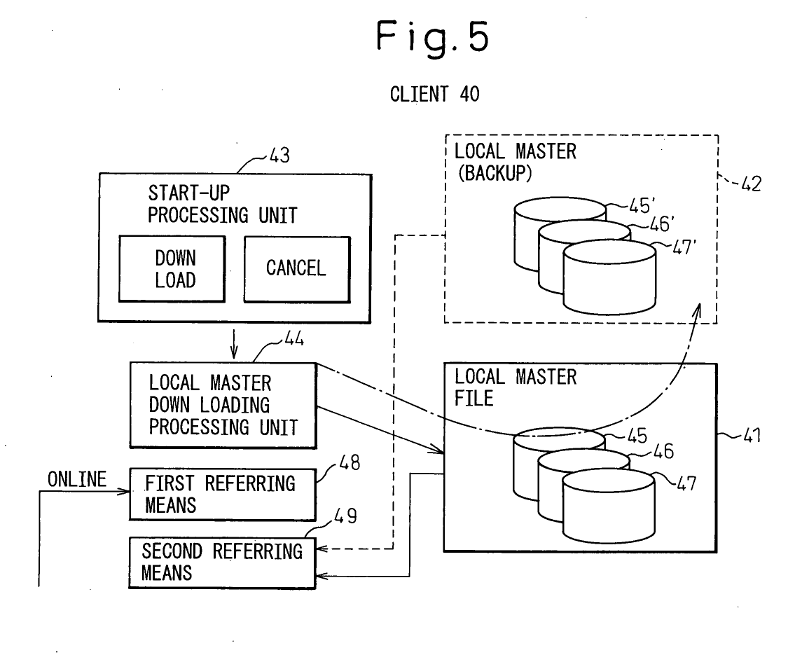

FIG. 5 is a diagram showing an example of the construction of the client (POS terminal) 40 including the local master file that is downloaded as the need arises from the web server shown in FIG. 4.

As the timing of the download, there is a time of start up of the client 40 or a periodical timing during operation of the client 40.

In the FIG. 41 is a local master file, 42 a local master file as a backup, 43 a start-up processing unit of the client, and 44 a download processing unit for down-loading the local master file from the web server.

When the downloading period is short or when it is required to reduce the hardware of the client 40, the local master file 42, as a backup, may be eliminated.

The local master file 41 includes a client PLU master file 45, a category class master file 46 representing category master files and classes in respective categories, and a sales person (person in charge) master file 47 for storing codes of the sales persons (persons in charge). The local master file 42 as a backup also includes a client PLU master file 451, a category class master file 46′ representing category master files and classes in respective categories, and a sales person (person in charge) master file 47′ for storing codes of the sales persons (persons in charge).

The client 40 further includes a first referring means 48 for referring a first master file prepared, in a relational database format, from the web server 30 during an online session, and a second referring means 49 for referring the local master file 41 or 42 during an offline session.

Next, the process for preparing the local master in the web server 30 will be described.

The start-up processing unit 31 of the web server 30 shown in FIG. 4 prepares a local master to be used in an offline mode by using the client PLU master file 21 in the database server 20 shown in FIG. 3, the category class master file 22, and the sales person (person in charge) master file 23. The prepared local master is stored as the client PLU master file 34, the category class master file 35, and the sales person (person in charge) master file 36 in the local master file 33.

At this time, the capacity of each of files in the local master file 33 prepared in the web server 30 is made to be smaller than the capacity of each of the files in the master file 20 in the database server 20. To this end, for example, a plurality of items (such as a standard price, a bargain sale price, a time bargain sale price, etc.) are made to be a single item, or items that are not used during an offline session (such as a start time, an end time, the number of packages to be sold at once within a specified time, the prices of the packages to be sold at once within a specified time, etc.) are deleted.

Next, a method for downloading the local master file 33 stored in the web server 30 into the client 40 will be described.

At the time of starting up the client 40, the operator of the POS terminal judges whether or not the local master file 33 stored in the web server 30 should be downloaded into the client 40. If it is judged that the local master file should be downloaded, the operator performs an action, such as pressing a downloading button, necessary for the downloading. Then, the contents of the current local master file 41 are saved in the local master file 42 as a backup. Then, the whole contents of the local master file 33 stored in the web server 30 are downloaded into the client 40. By performing the backup operation, even after a failure in the down-loading, the original local master file 42 can be utilized so that the reliability is ensured.

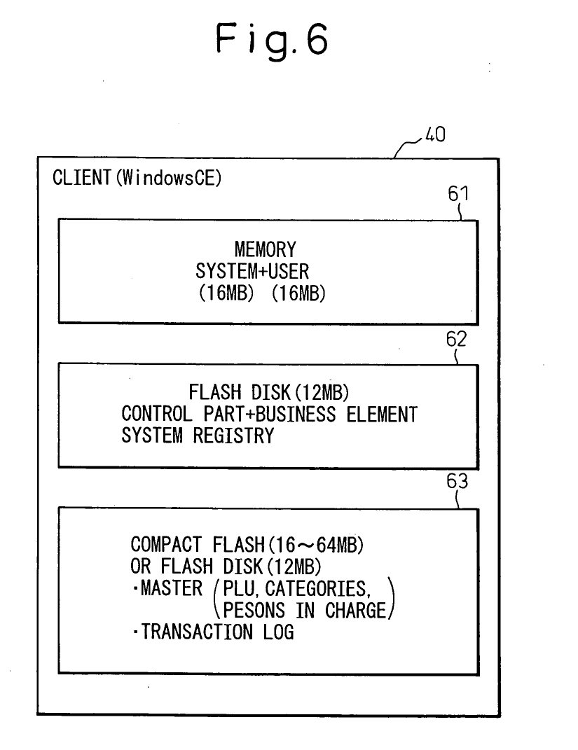

FIG. 6 is a block diagram showing an example of the construction of the storing unit in the client 40. In the figure, the operating system (OS) of the client 40 is the Windows CE. The client 40 includes a memory 61, a flash disk 62, and a compact flash memory or a flash disk memory 63. The OS of the client 40 is not limited to Windows CE.

The memory 61 has a region of 16 MB for the system and a region of 16 MB for a user.

The capacity of the flash disk memory 62 is 12 MB, and it is used for a system registry such as a control part for controlling a printer, scanner or any other peripheral equipment of the POS system, or software parts performing the POS business based on the information derived from the control part.

The compact flash memory or the flash disk memory 63 is provided according to the embodiment of the present invention. It is used to record the local master files used during the offline session and transaction log. The compact flash memory may be 16-64 MB, and the flash disk memory is 12 MB. However, the capacity is not limited to the above. The contents of the local master file includes, as described before, the client PLU master file 45 having a capacity smaller than the capacity of the database 20, the category class master file 46 for storing the category master files and classes of the respective categories, and the sales person (person in charge) master file 47 for storing the codes of the sales persons (persons in charge).

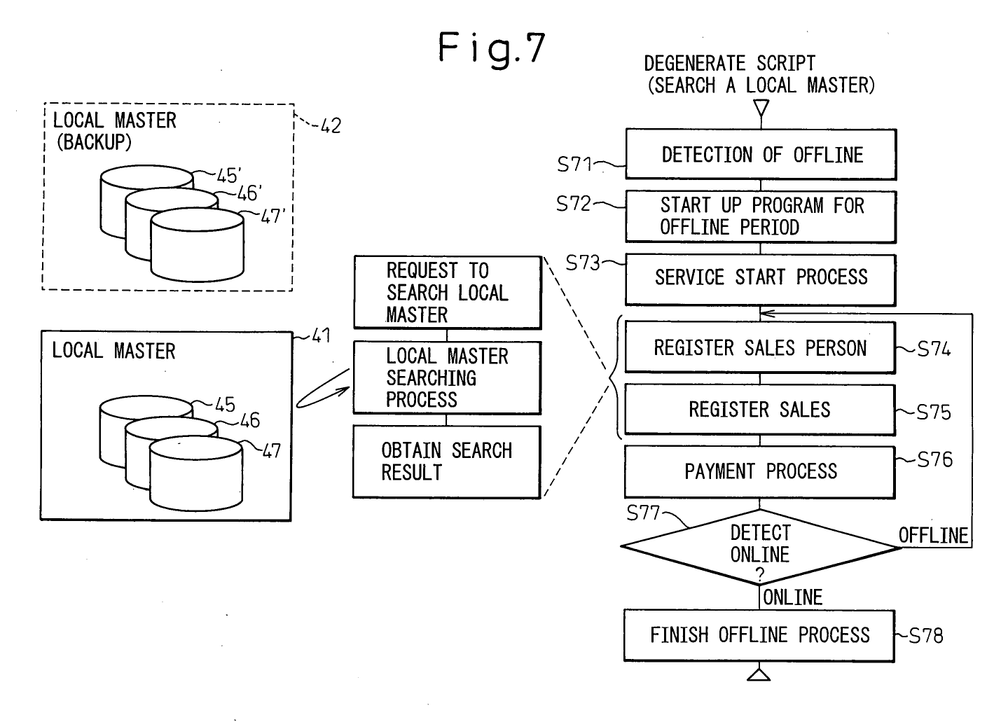

FIG. 7 is a flowchart for explaining the operation in the client 40 when searching the local master file during an offline session. During the offline session, the amount of data is smaller than that during the online session. In addition, the program is written as a text file. Therefore, in the figure, there is an expression “degenerate script”.

In the figure, at step S71, when trouble occurs between the database server 20 and the web server 30 or between the web server 30 and the client 40 so that an offline condition is detected, the process proceeds to step S72 wherein an operator operates the POS terminal to start up the program for the offline session. Then, at step S73, a service start process of the local master file 41 is carried out. When the local master file 41 starts to provide services, a search request is given to the sales person (person in charge) master file 47 at steps S74 and S75. As a result of the search process, a sales person and the sales are registered at the POS terminal.

Then, at step S76, a payment by a customer is carried out. Then, at step S77, it is judged whether or not the period is the online session. If it is still the offline session, steps S74-S76 are repeated.

At step S77, when an online session is detected, an offline finishing process is carried out at step S78 and then the process transfers to the online state.

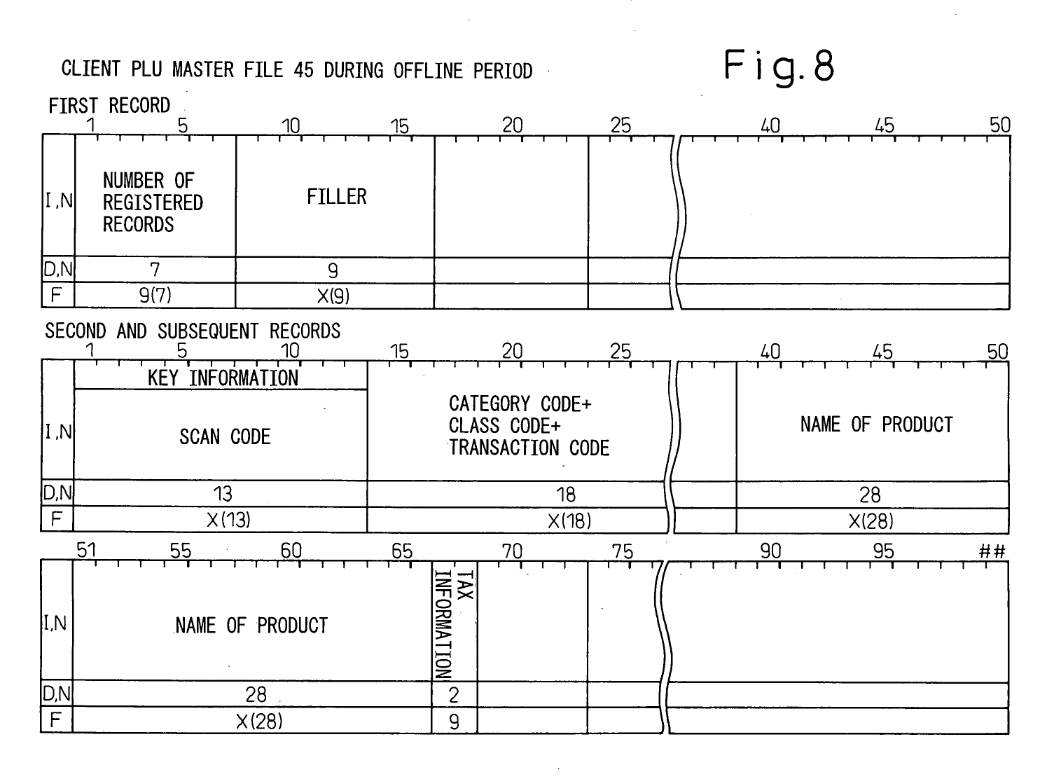

FIG. 8 to FIG. 11 show an example of the contents of the local master file 41 used during an offline session.

FIG. 8 is a diagram showing an example of the contents of the client PLU master file 45 during an offline session. In this example, the client PLU master file 45 consists of a first record, a second record and a third record. Each record has a size of 50 bytes. In the figure and in the following figures, I.N. represents an item name, D.N. represents a digit number, and F represents a form. When the form F is “9”, this means that a numeral having a digit number expressed by the numeral in the bracket after the numeral 9 is input. When the form F is “X”, this means that characters having a digit number expressed by the numeral in the bracket after the character X is input.

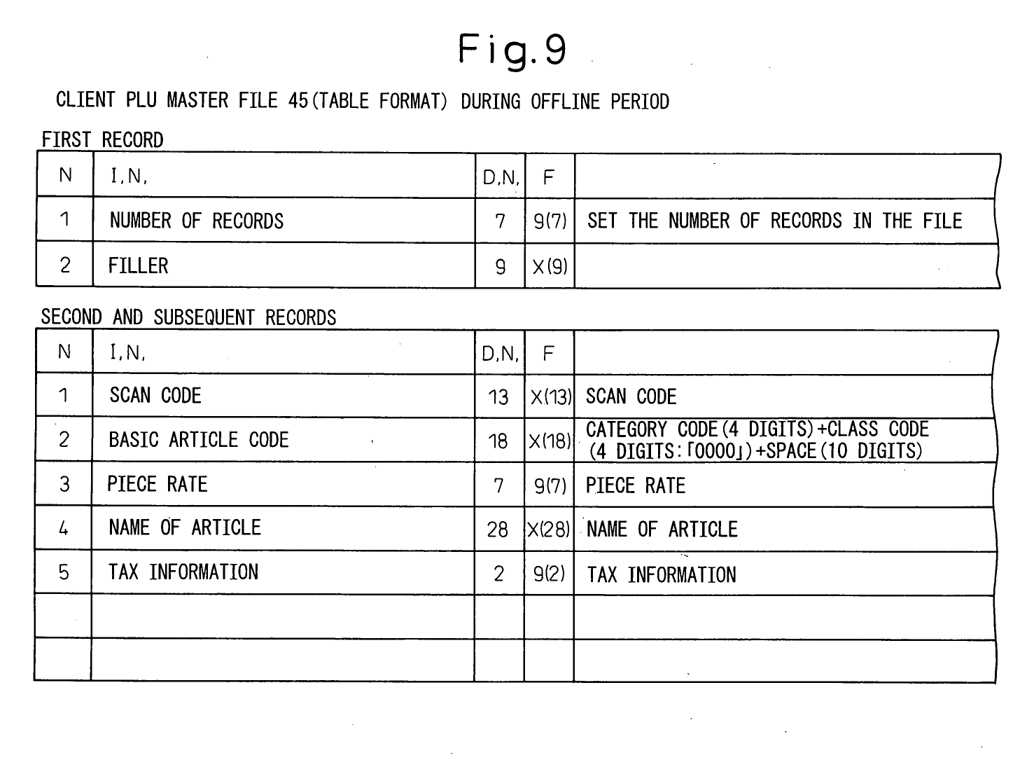

FIG. 9 is a diagram showing a table of the contents of the client PLU master file 45 shown in FIG. 8.

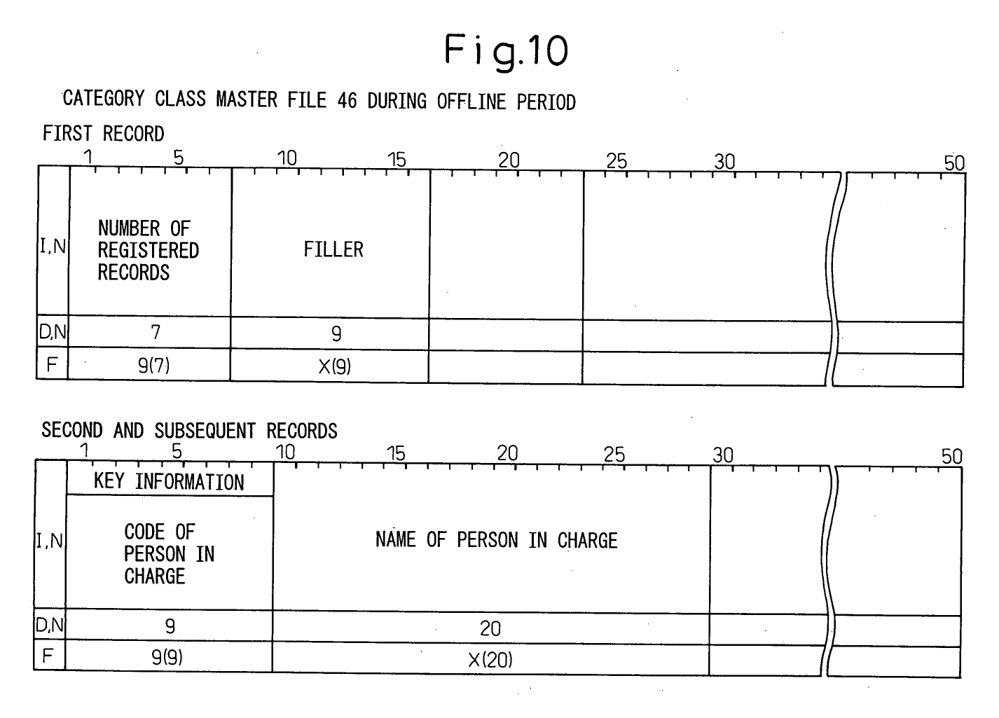

FIG. 10 is a diagram showing an example of the contents of the category class master file 46 during an offline session. In this example, the category class master file 46 includes a category master file consisting of a first record of 50 bytes and a second record of 50 bytes and a class master file also consisting of a first record of 50 bytes and a second record of 50 bytes.

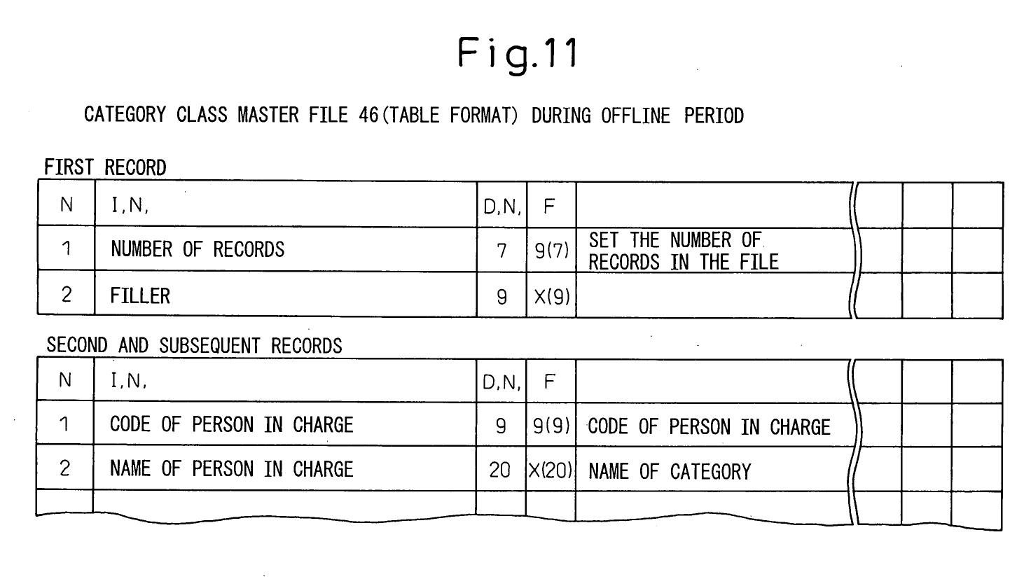

FIG. 11 is a diagram showing, in a table, the contents of the category class master file 46 as shown in FIG. 10.

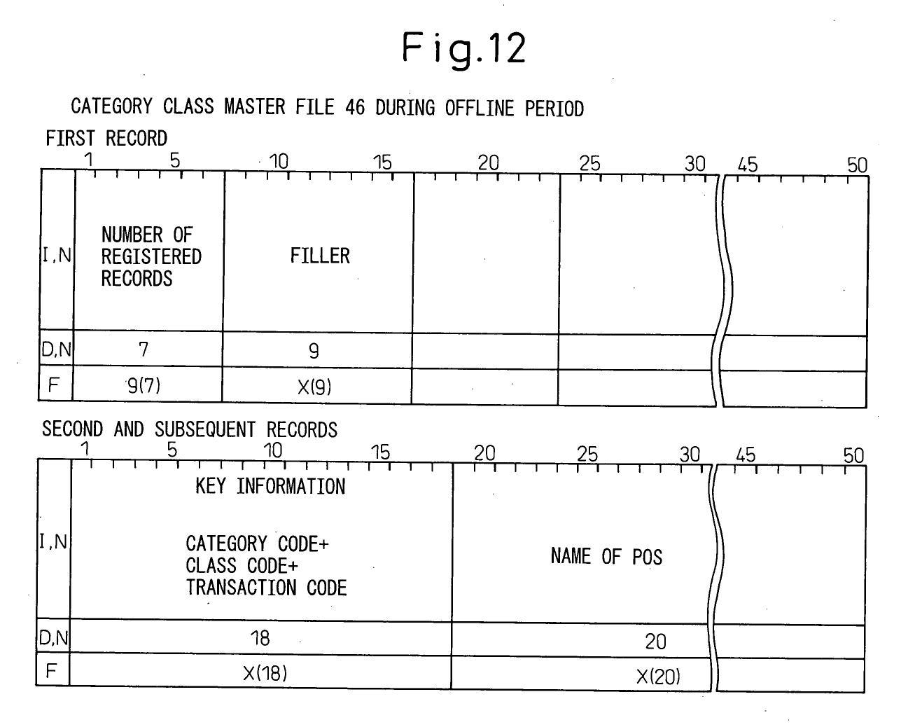

FIG. 12 is a diagram showing an example of the contents of the sales person (person in charge) master file 47 during an offline session. In this example, the sales person (person in charge) master file 47 includes a master file for sales persons and a file for persons in charge. Each master file consists of a first record and a second record. The size of each record is 50 bytes.

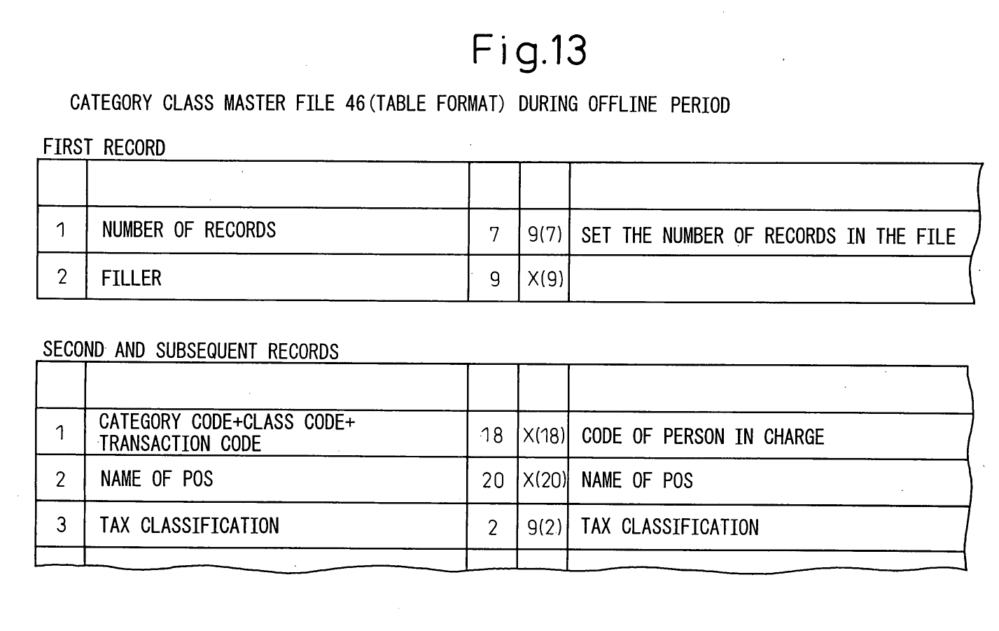

FIG. 13 is a diagram showing, in a table, the contents of the sales person (person in charge) master file 47 shown in FIG. 12.

Each of the master files during offline session shown in FIGS. 8-13 has a data capacity smaller than the data capacity of the master file during an online session. For example, each record in the client PLU master file during an online session is as large as 600 bytes, although it is not shown in the figure. In the record during an online session, there are items of a standard price, a special price, a time bargain price, or the like separately. In contrast, in the client PLU master file during an offline session, these items are put into one item. Also, in the client PLU master file during the online session, there are information such as a start time for using the POS terminal, a finish time, the number of time packages, the price of time packages, etc. which are not used during the offline session. In contrast, in the client PLU master file 45 during the offline session, this information is not included. In this way, by reducing the amount of the information, the POS terminal without having a hard disk can continue the selling activity by means of a semiconductor memory such as a compact flash only, even when the communication between the POS terminal and the web server turns to an offline state.

As is apparent from the foregoing description, according to the present invention, even when the client in the POS system does not have a hard disk, registration work is possible during an offline session, so that it becomes possible to prevent business stopping due to trouble with the hard disk.

What is claimed is:

1. A POS system including a server and a client, comprising:
a first master file formed in a relational data base format and used during an online session between the server and the client; and
a second master file formed in a text format, having a capacity smaller than the first master file, and used during an offline session between the server and the client;
the second master file being down loaded from the server to the client at a time when it is necessary for the client:
the client comprising:
a first referring means referring the first master file; and
a second referring means referring the second master file;
the referring means being switched in such a way that, during an online session, the first master file being referred to by the first referring means; and
during an offline session, the second master file being referred to by the second referring means.

2. A POS system according to claim 1, wherein the client is a thin client without a hard disk.

3. A POS system according to claim 1, wherein the time when it is necessary for the client is a time at which the client starts service.

4. A POS system according to claim 1, wherein the capacity of the second master file is reduced by making a plurality of items in the first master file one item in the second master file.

5. A POS system according to claim 1 or 4, wherein the capacity of the second master file is reduced by deleting, from the first master file, items which are not used, during the offline session, to form the second master file.

6. A POS system according to claim 1, wherein the client comprises a compact flash memory for storing the second master file.

7. A POS system according to claim 1, wherein the client comprises a flash disk memory for storing the second master file.
